(19) United States
(12) Patent Application Publication
(10) Pub. No.: US 2009/0197144 A1
(43) Pub. Date: Aug. 6, 2009

(54) Switch valve applied to a cartridge of a fuel cell

(75) Inventors: Tsan-Fu Tseng, Hsin-Chu (TW); Jung-Chi Chen, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsin-Chu (TW)

(21) Appl. No.: 12/318,704

(22) Filed: Jan. 7, 2009

(30) Foreign Application Priority Data
Feb. 4, 2008 (TW) 097104141

(51) Int. Cl. H01M 2/00; F16L 37/00

(52) U.S. Cl. 429/34; 137/614.04

(57) ABSTRACT

A switch valve applied to a cartridge of a fuel cell includes a first valve body and a second valve body. The first valve body has a first connecting member and a first slide member which may slide relative to the first connecting member. The second valve body has a second connecting member and a second slide member which may slide relative to the second connecting member. The second connecting member is used to lock the first connecting member. During assembling operation of the first and the second valve bodies, the first connecting member gets the second slide member moving to open the second valve body; and then the second connecting member gets the first slide member moving to open the first valve body. During disassembling operation of the first and the second valve bodies, the first valve body is closed before the second valve body is closed.

### BACKGROUND OF THE INVENTION

(1) Field of the Invention

The present invention relates to a switch valve, and more particularly relates to a switch valve applied to a cartridge of a fuel cell.

(2) Description of the Prior Art

The exploitation and the application of energy destroy the environment day by day. Due to the advantages of high efficiency, low noise and no pollution, the fuel cell accords with the environmental protection trend. There are many types of fuel cells, in which proton exchange membrane fuel cell (PEMFC) and direct methanol fuel cell(DMFC) are most popular. The structure of the fuel cell is explained in following in the example of DMFC.

Referring to FIG. 1, a conventional DMFC 100 has a methanol cartridge 120, a flow switch 140, a pump 160, a fuel cell stack 180 and a pipeline 110. Referring to FIG. 2, the fuel cell stack 180 mainly includes a cathode 182, an anode 184 and a proton exchange membrane 186.

As shown in FIG. 2, the fuel(methanol) in the anode 184 reacts with the catalyst(not shown) to generate hydrogen ions and electrons. The electrons at the anode 184 reach the cathode 182 along an outer circuit 188. The hydrogen ions reach the cathode 182 through the proton exchange membrane 186, and react with the electrons and oxygen to generate water.

Referring to FIG. 1, the methanol cartridge 120 is used to deposit the methanol required at the anode 184. The flow switch 140 is connected between the methanol cartridge 120 and the pipeline 110, controlling the methanol from the methanol cartridge 120 to the pump 160. The pump 160 assists the methanol entering the fuel cell stack 180 in a stable flow, to generate power by reaction.

Refer to FIG. 3 for the structure of the conventional flow switch 140. The flow switch 140 includes two valves 142 and 144. For quick connection and disconnection of the methanol cartridge 120 and the pipeline 110, the valves 142 and 144 are connected to the methanol cartridge 120 and the pipeline 110 respectively. Hence, users can replace the methanol cartridge 120 in the fuel cell 100 quickly and conveniently.

The valves 142 and 144 have a slide member 146 and 141 respectively, which slides linearly to open or close the valves 142 and 144, so as to control the methanol flowing through the flow switch 140 or not.

Refer to FIGS. 4A-4E for the schematic views of the actions of the flow switch 140. FIGS. 4A-4C are the steps for connecting the valve 142 disposed on the methanol cartridge 120 to the valve 144 disposed on the pipeline 110. In FIG. 4B, the slide members 146 and 141 of the valves 142 and 144 move a little in the open direction at the same time, to make less methanol to flow through the valve 142 disposed on the methanol cartridge 120 and the valve 144 disposed on the pipeline 110. In FIG. 4C, the slide members 146 and 141 of the valves 142 and 144 move in the utmost in the open direction at the same time, to make a lot of methanol to flow from the methanol cartridge 120 to the pipeline 110.

FIGS. 4D-4E are the steps for the disconnecting the valve 142 disposed on the methanol cartridge 120 from the valve 144 disposed on the pipeline 110. In FIG. 4D, the slide members 146 and 141 of the valves 142 and 144 move a little in the close direction at the same time, to reduce the methanol to flow through the valve 142 disposed on the methanol cartridge 120. In FIG. 4E, the slide members 146 and 141 of the valves 142 and 144 move in the utmost in the close direction at the same time, to stop the methanol to flow out from the methanol cartridge 120.

In addition, some methanol remains outside the valve 142 disposed on the methanol cartridge 120, which will drop in the inner wall of the valve 144 disposed on the pipeline 110. Because the valve 144 disposed on the pipeline 110 is closed completely, the remaining methanol is unable to flow into the pipeline 110. The methanol is poisonous, so if it remains at the connection portion of the methanol cartridge 120 and the pipeline 110, it will bring a safety concern to the users.

### SUMMARY OF THE INVENTION

The embodiments of the present invention is to provide a switch valve applied to a cartridge of a fuel cell, and capable of preventing the methanol from leaking in the process of assembling/disassembling the switch valve for replacing the fuel cartridge.

According to an embodiment of the present invention, a switch valve includes a first valve body and a second valve body. The first valve body has a first connecting member and a first slide member capable of sliding relative to the first connecting member. The second valve body has a second connecting member for locking the first connecting member and a second slide member capable of sliding relative to the second connecting member. During assembling operation of the first and the second valve bodies, the first connecting member gets the second slide member moving to open the second valve body, and the second connecting member gets the first slide member moving to open the first valve body. During disassembling operation of the first and the second valve bodies, the first valve body is closed before the second valve body is closed.

According to another embodiment of the present invention, a fuel cell includes a cartridge, a mentioned switch valve, a pipeline, a pump and a fuel cell stack. The first valve body of the switch valve is connected to the cartridge. One end of the second valve body is connected to the first valve body. The pipeline is connected to the other end of the second valve body. The pump is connected to the pipeline. The fuel cell stack is connected to the pump. Specially, during assembling operation of the first and the second valve bodies, the first connecting member gets the second slide member moving to open the second valve body; and the second connecting member gets the first slide member moving to open the first valve body, while during disassembling operation of the first and the second valve bodies, the first valve body is closed before the second valve body is closed.

Preferably, the first slide member of the first valve body is disposed an axle center of the first connecting member. The second connecting member of the second valve body has a trough for the insert of the first valve body, and the second slide member is protrudent on the bottom of the trough. An inner wall of the trough has a block. A slide groove is disposed on an outer wall of the first connecting member and has a first locking position and a second locking position. After inserted into the first locking position and moved a distance, the block is locked at the second locking position.

In an embodiment of the present invention, the first connecting member of the first valve body has a first end surface for touching the second slide member, while the first slide member has a second end surface for touching the second connecting member, with a height difference between the first end surface and the second end surface. In another aspect, the bottom of the trough of the second connecting member has a protrusion, and the height of the protrusion is lower than the height of the second slide member above the bottom of the trough.

In an embodiment of the present invention, the first connecting member of the first valve body has a positioning post, and the second connecting member of the second valve body has a positioning notch for the insert of the positioning post. Note that the distance between the two locking positions is equal to the length of the positioning post.

In an embodiment of the present invention, the switch valve further includes a foam filling around the second slide member, and also includes a seal ring between the first connecting member and the second connecting member.

In an embodiment of the present invention, the first valve body has a spring and a rolling ball disposed between the first connecting member and the first slide member.

In conclusion, the switch of the present invention may ensure the assembling of the two switch valves and no damage, and ensure no fuel remaining in the switch valve.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic view of a conventional direct methanol fuel cell (DMFC).

FIG. 2 is a schematic view of a fuel cell stack of the conventional DMFC.

FIG. 3 is a schematic view of a flow switch of the conventional DMFC.

FIGS. 4A-4E are schematic views of the actions of the flow switch of the conventional DMFC.

FIGS. 5A and 5B are schematic views showing the first embodiment of the switch valve according to the present invention.

FIG. 6 is a schematic view showing the second embodiment of the switch valve according to the present invention.

FIGS. 7A-7C are schematic views of the slide groove of the switch valve based on the embodiment according to the present invention.

FIG. 8 is a schematic view showing the embodiment of the fuel cell according to the present invention.

FIGS. 9A-9E are schematic views of the actions of the switch valve based on the embodiment according to the present invention.

FIGS. 10A-10E are schematic views of the actions of the switch valve based on the embodiment according to the present invention.

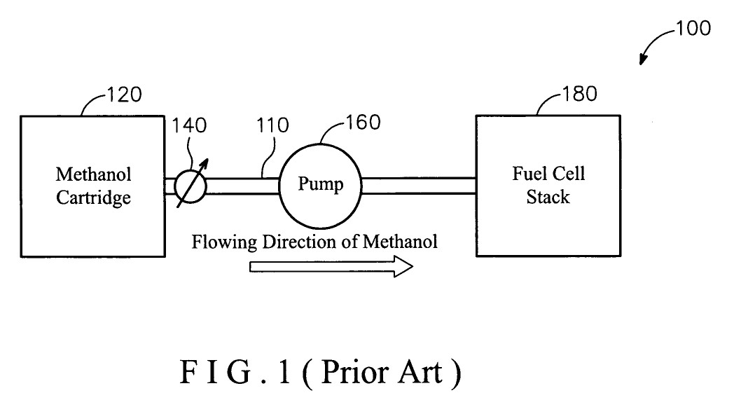

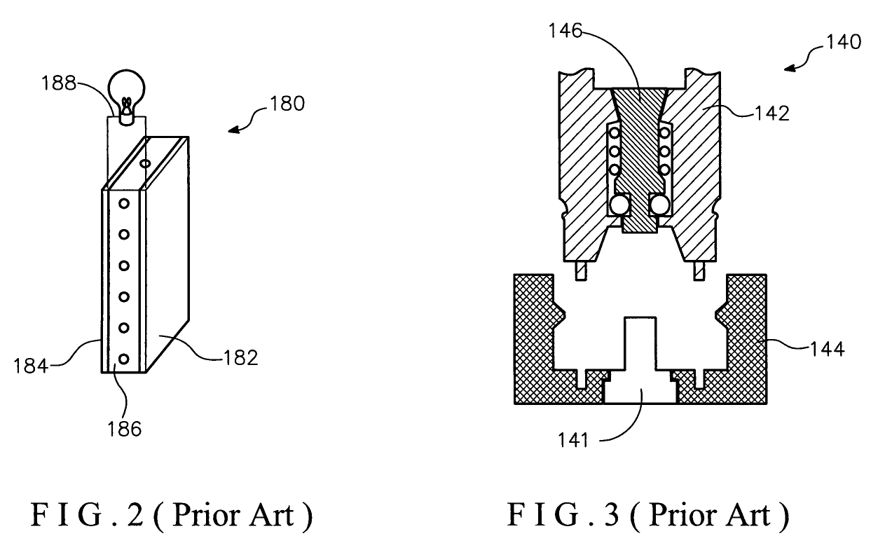

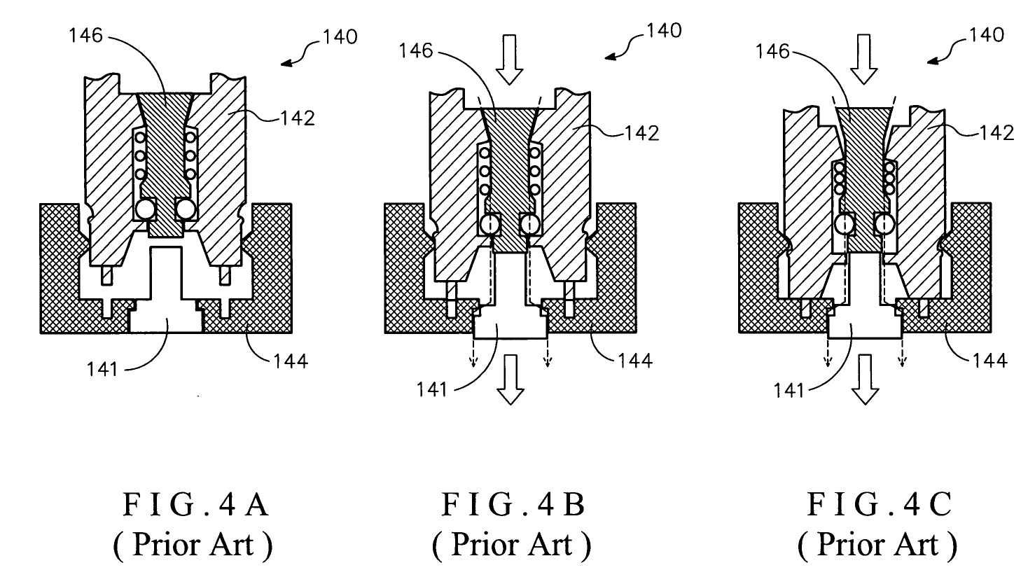

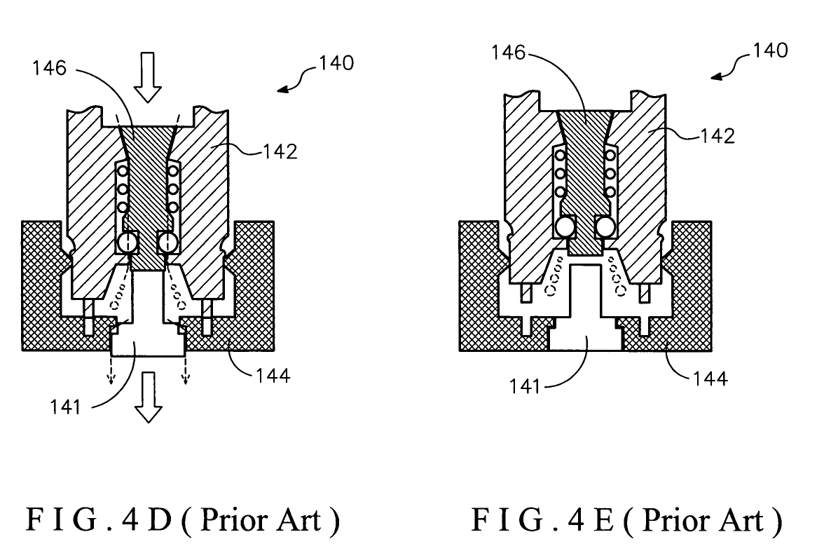

### DESCRIPTION OF THE PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component directly or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

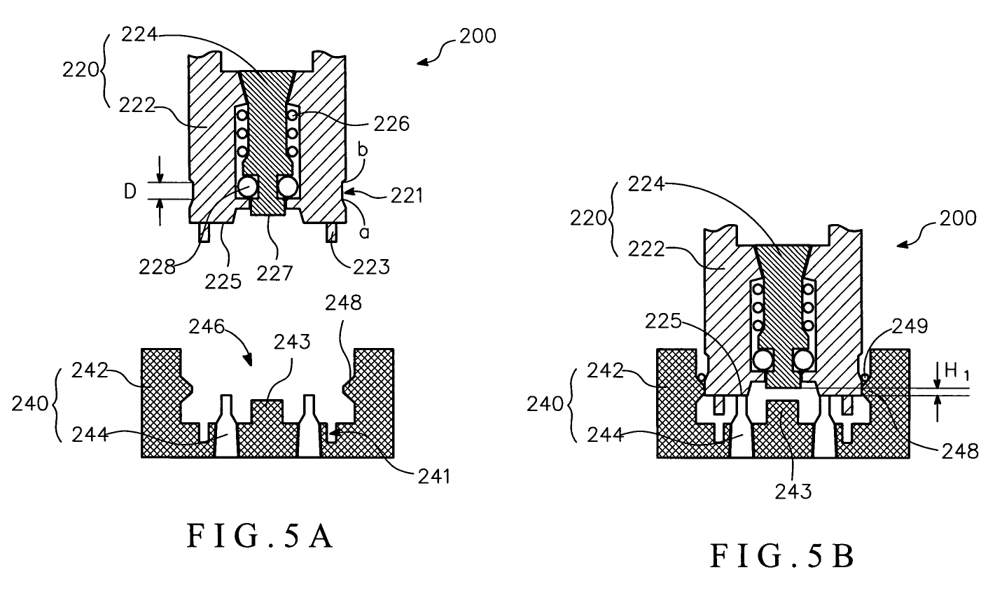

Referring to FIG. 5A, a switch valve 200 includes a first valve body 220 and a second valve body 240. The switch valve 200 is used to connect the fuel cartridge of the fuel cell with the pipeline. The first valve body 220 has a first connecting member 222 and a first slide member 224, disposed on the fuel cartridge. The first slide member 224 is capable of sliding relative to the first connecting member 222. The second valve body 240 has a second connecting member 242 and a second slide member 244, disposed on the opening of the pipeline. The second connecting member 242 is used to lock the first connecting member 222. The second slide member 244 is able to slide relative to the second connecting member 242.

The structure of the first valve body 220 is described as follows. In a preferable embodiment, the first slide member 224 is disposed on the axle center of the first connecting member 222. A spring 226 and a rolling ball 228 are disposed between the first connecting member 222 and the first slide member 224 to make the first slide member 224 to slide up and down linearly. In addition, the first connecting member 222 has a positioning post 223 at the lower end, and also a slide groove 221 on the outer wall. The slide groove 221 has a first locking position “a” and a second locking position “b”. In the embodiment, the slide groove 221 may not be disposed on the outer wall of the first connecting member 222, only marking the first locking position “a” and the second locking position “b”.

The structure of the second valve body 240 is described as follows. In a preferable embodiment, the second connecting member 242 defines a trough 246 for the insert of the first valve body 220. Especially, the size of the trough 246 is fit for the first connecting member 222. The second valve body 240 further includes a block 248 disposed or protrudent on the inner wall of the defined trough 246. During assembling operation of the first valve body 220 and the second valve body 240, the block 248 first gets stuck in the first locking position “a”, then moves a distance D to get stuck in the second locking position “b”. The second slide member 244 is disposed in the second connecting member 242, protrudent on the bottom of the trough 246, and also may slide up and down linearly in the trough 246. The second slide member 244 in FIG. 5A is a ring protrusion. The second connecting member 242 of the second valve body 240 has a positioning notch 241 for the insert of the positioning post 223 of the first valve body 220.

Referring to FIGS. 5A and 5B, the first connecting member 222 of the first valve body 220 in FIG. 5A has a first end surface 225, while the first slide member 224 has a second end surface 227. When the first valve body 220 is inserted into the trough 246 of the second valve body 240, the first end surface 225 corresponds to the top of the second slide member 244, while the second end surface 227 corresponds to the protrusion 243 at the bottom of the second connecting member 242.

In addition, as shown in FIG. 5B, the position of the first end surface 225 is lower than that of the second end surface 227, so there is a height difference H1 between the first end surface 225 and the second end surface 227. Thus, during assembling operation of the first valve body 220 and the second valve body 240, the first end surface 225 presses down the top of the second slide member 244, and then the protrusion 243 pushes up the bottom of the first slide member 224, making the second valve body 240 and the first valve body 220 open at different time orderly. On the contrary, during disassembling operation of the first valve body 220 and the second valve body 240, the protrusion 243 is detached from the bottom of the first slide member 224, making the first slide member 224 down to close the first valve body 220, and the remaining methanol outside the first valve body 220 enters the second valve body 240; then, the first end surface 225 is detached from the top of the second slide member 244, making the second valve body 240 closed to ensure no fuel remaining in the switch valve 200. Additionally, for better avoiding leakage, a seal ring 249, such as an O-ring, may be added between the block 248 and the slide groove 221.

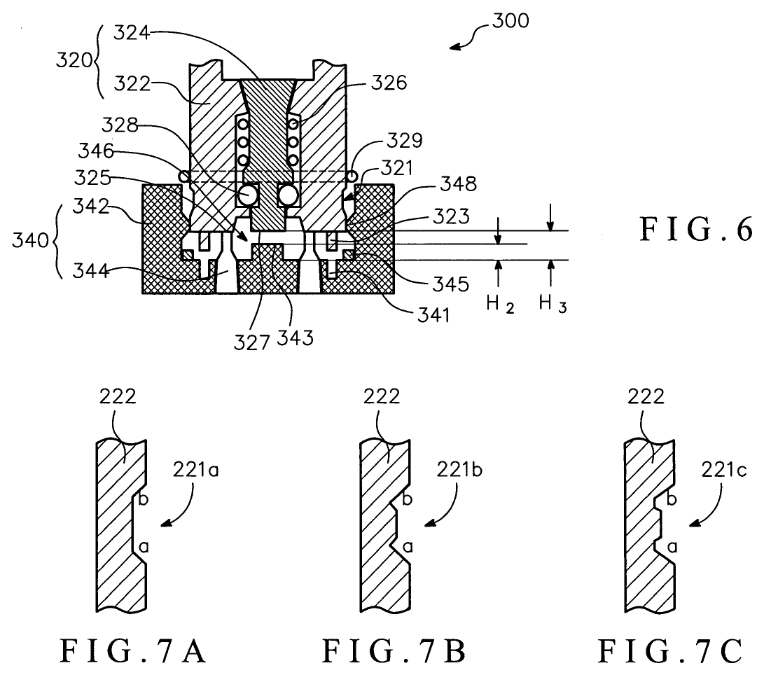

Referring to FIG. 6, in another embodiment, the switch valve 300 includes the first valve body 320 and the second valve body 340. The height H2 of the protrusion 343 of the second connecting member 342 in the second valve body 340 is lower than the height H3 of the second slide member 344 above the bottom of the trough 346, but the first end surface 325 and the second end surface 327 may be at the same level. Thus, during assembling operation of the first valve body 320 and the second valve body 340, the first end surface 325 first contacts the top of the second slide member 344 and presses it down; then the protrusion 343 contacts the bottom of the first slide member 324(the second end surface 327) and pushes it up. In this way, the first valve body 320 and the second valve body 340 may be opened in order and closed in a reverse order. However, the invention is not limited to this structure. It is acceptable as long as when the first end surface 325 contacts the top of the second slide member 344, but does not push the second slide member 344, the bottom or the side wall of the trough 346 are defined not touching the bottom of the first slide member 324.

In a preferable embodiment, the mentioned switch valve 300 further includes a foam 345 filling outside the first slide member 324 or the second slide member 344 to avoid fuel leakage. In addition, a seal ring 329 may be added between the first connecting member 322 and the second connecting member 342 to connect the first connecting member 322 and the second connecting member 342 more closely for airproof and leakage proof. In this embodiment, there is no detailed description of the relative movement of the slide groove 321 and the block 348, the relationship of the positioning post 323 and the positioning notch 341 and the action of the spring 326 and the rolling ball 328. The former embodiment may be referred to.

FIGS. 7A-7C are the equivalent structures 221a, 221b and 221c of the slide groove 221. In FIG. 7A, the locking positions “a” and “b” are inside the slide groove 221a, and has a interior corner structure. In FIG. 7B, the locking positions “a” and “b” are inside the slide groove 221b, and has a concave structure with corner-shaped profile. In FIG. 7C, the locking positions “a” and “b” are inside the slide groove 221c, and has a concave structure with rectangle-shaped profile.

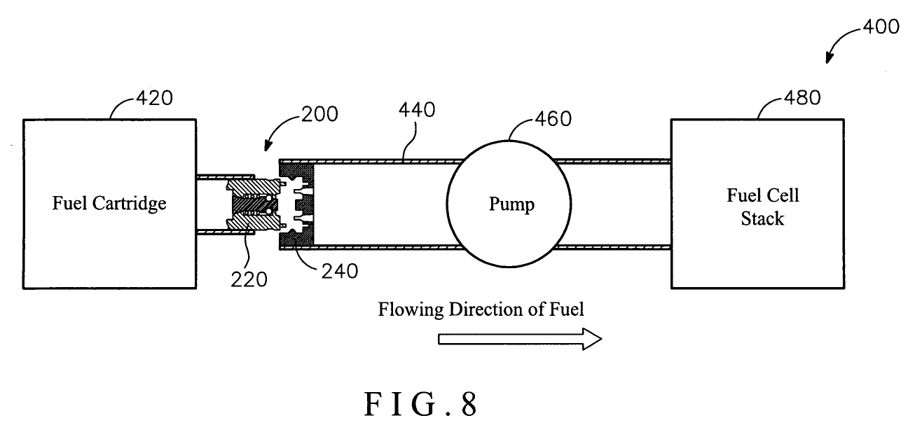

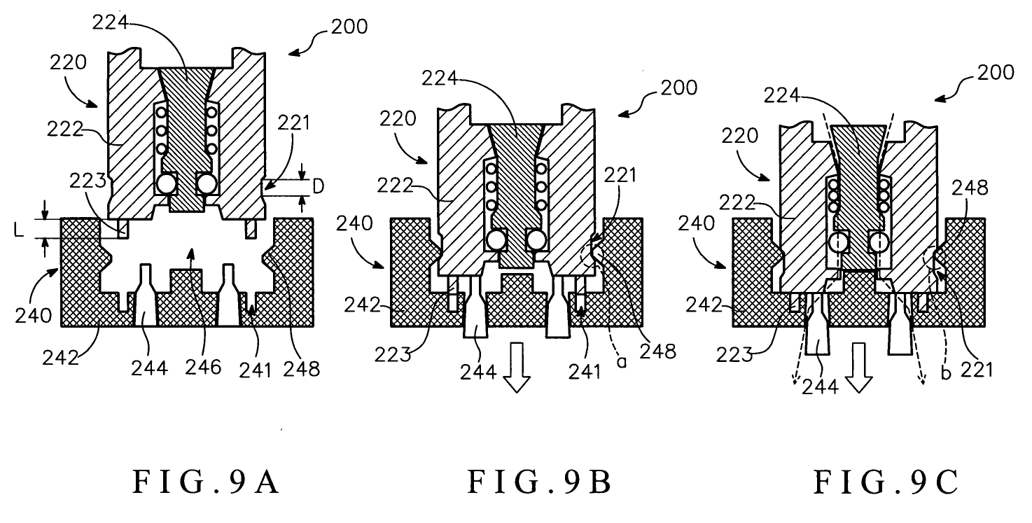

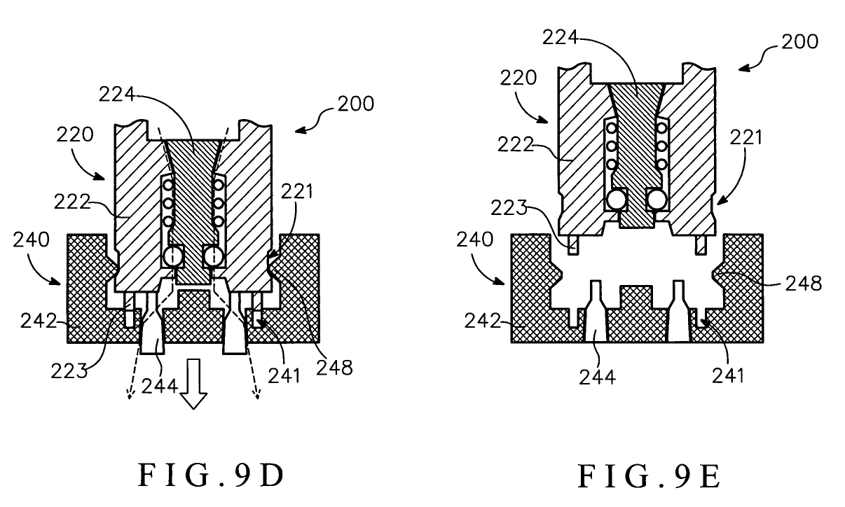

Referring to FIG. 8, the fuel cell 400 includes the fuel cartridge 420, the mentioned switch valve 200, the pipeline 440, the pump 460 and the fuel cell stack 480. The first valve body 220 of the switch valve 200 is connected to the fuel cartridge 420. One end of the second valve body 240 is connected to the first valve body 220, the other end is connected to the pipeline 440. The pipeline 440 is connected to the pump 460, while the pump 460 is connected to the fuel cell stack 480 to assist the fuel entering the fuel cell stack 480 in a stable flow to generate power. During assembling operation of the first valve body 220 and the second valve body 240, the first valve body 220 opens after the second valve body 240 is open. During disassembling operation of the first valve body 220 and the second valve body 240, the second valve body 240 closes after the first valve body 220 is closed. The switching process and function of the switch valve 200 refers to the explanation in FIGS. 9A-9E.

Additionally, the way for inserting/removing the fuel cartridge 420 is rotation, which may increase the location correctness of the inserting/removing to avoid leakage. Preferably, the pump does not move until the first valve body 220 of the fuel cartridge 420 inserts the second valve body 240. The pump 460 opens only when the block 248 is located at the first locking position “a”. When the slide groove 221 leaves the block 248, the pump 460 closes.

Referring to FIGS. 9A-9E, during assembling operation of the first valve body 220 and the second valve body 240, the first connecting member 222 gets the second slide member 244 moving down to open the second valve body 240; then the second connecting member 242 gets the first slide member 224 moving up to open the first valve body 220. Thus, the second valve body 240 at the pipeline 440 opens to let the fuel outside the pipeline 440 flow into the pipeline 440. On the contrary, during disassembling operation of the first valve body 220 and the second valve body 240, the first valve body 220 is closed to close the fuel cartridge 420, but the second valve body 240 of the pipeline 440 is kept open at the same time, to let the fuel inside the second valve body 240 flow into the pipeline 440, and then the second valve body 240 is closed.

The detailed description is as follows. In FIG. 9B, when the block 248 of the second valve body 240 at the pipeline 440 inserts the lowest position (the first locking position “a”) of the slide groove 221 of the first valve body 220 in the fuel cartridge 420, the second slide member 244 at the pipeline 440 is moved in the open direction. If there is remaining fuel inside the second valve body 240, such as methanol, it may flow into the fuel cell stack 480 through the pipeline 440, while the first valve body 220 in the fuel cartridge 420 is completely closed.

Referring to FIG. 9C, when the block 248 inserts the highest position (the second locking position “b”) of the slide groove 221 of the first valve body 220, the first valve body 220 and the second valve body 240 at the fuel cartridge 420 and the pipeline 440 are both open. Then a large quantity of the fuel flows through the first valve body 220 and the second valve body 240 and enters the fuel cell stack 480 in a stable flow by the push of the pump 460.

Referring to FIG. 9D, when the first valve body 220 is to detach from the second valve body 240, the block 248 moves to the lowest position of the slide groove 221. Since the first valve body 220 at the fuel cartridge 420 is closed, no fuel flows out. At the same time, the second valve body 240 at the pipeline 440 is opened a little, so the fuel remaining between the first valve body 220 and the second valve body 240 is absorbed into the fuel cell stack 480.

Referring to FIG. 9E, when the first valve body 220 is detached from the second valve body 240, if the distance between the highest position and the lowest position is designed properly, it may be avoided that the fuel remains at the connection portion of the fuel cartridge 420 and the pipeline 440.

Referring to FIG. 9B, when the positioning post 223 moves to the opening of the positioning notch 241, the block 248 is just at the first locking position “a”. As shown in FIG. 9C, when the positioning post 223 inserts the positioning notch 241 completely, the block 248 just moves to the second locking position “b”. So the distance D between the first locking position “a” and the second locking position “b” should be the length L of the positioning post 223.

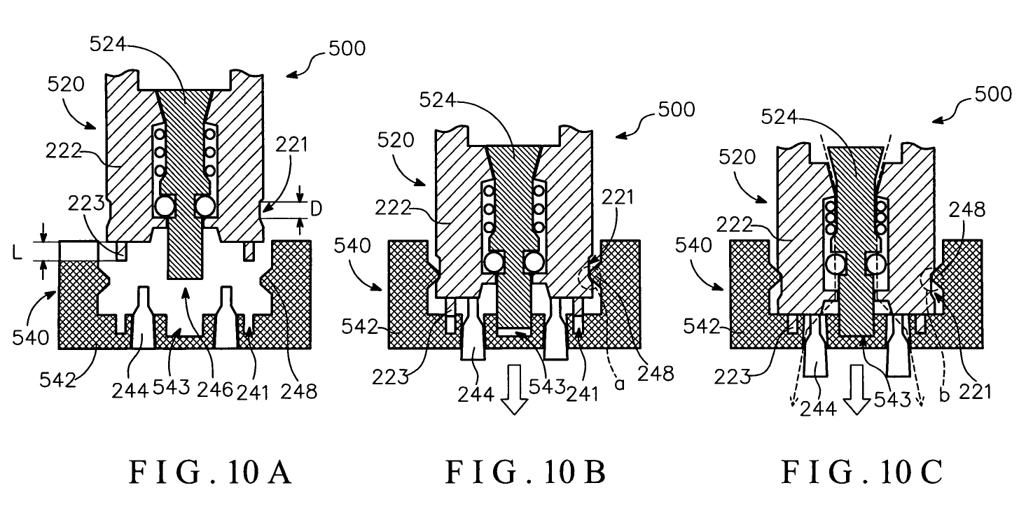

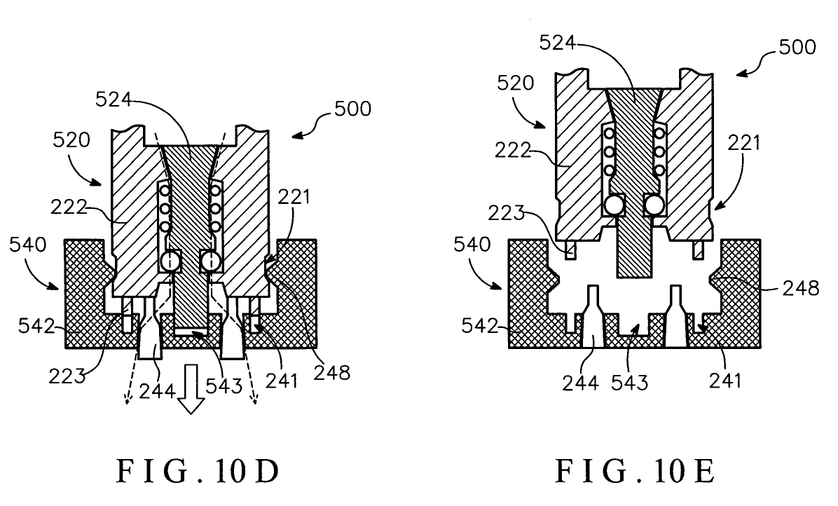

Referring to FIGS. 10A-10E, the action of the switch valve 500 is the same as FIGS. 9A-9E, but the structures of the first valve body 520 and the second valve body 540 are not the same as the former. The first valve body 520 has a first slide member 524, and the bottom of the first slide member 524 is more protrudent than that of the former first slide member 224. To match the structure of the first slide member 524, the second connecting member 542 of the second valve body 540 has a depressed part 543 in the middle of the inner bottom of the second connecting member 542 to hold the first slide member 524. Thus, when the first connecting member 222 presses down the second slide member 244 to open the second valve body 540, the bottom of the first slide member 524 still does not touch the bottom of the depressed part 543, so the first valve body 520 is still closed and it does not open until the bottom of the first slide member 524 still touches the bottom of the depressed part 543.

In conclusion, the switch valves 200 or 300 in the embodiment of the present invention use the two-step positioning (the first locking position “a” and the second locking position “b”) to avoid leakage. When applied in the small and thin fuel cell, it may achieve at least one of the following effects.
1. Ensuring the assembling of the two switch valves and no damage. When the first valve body 220 or 320 at the fuel cartridge 420 inserts the second valve body 240 or 340 at the pipeline 440, the two-step action, such as in FIGS. 9A-9B and FIGS. 9B-9C, ensures the correct positions of assembling. Thereby, the switch valves 200 or 300 would not be damaged by careless assembling.
2. Ensuring no fuel remaining in the switch valves 200 or 300. When the first valve body 220 or 320 at the fuel cartridge 420 is detached from the second valve body 240 or 340 at the pipeline 440, the two-step action, such as in FIGS. 9C-9D and FIGS. 9D-9E, ensures the remaining fuel entering the fuel cell stack 480 through the pipeline 440.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A switch valve, applied to a cartridge of a fuel cell, the switch valve comprising:
a first valve body, comprising a first connecting member and a first slide member capable of sliding relative to the first connecting member; and
a second valve body, comprising a second connecting member for locking the first connecting member and a second slide member capable of sliding relative to the second connecting member,
wherein during assembling operation of the first valve body and the second valve body, the first connecting member gets the second slide member moving to open the second valve body, and the second connecting member gets the first slide member moving to open the first valve body; during disassembling operation of the first valve body and the second valve body, the first valve body is closed before the second valve body is closed.

2. The switch valve of the claim 1, wherein the second connecting member of the second valve body has a trough for the insert of the first valve body, and the second slide member is protrudent on the bottom of the trough.

3. The switch valve of the claim 1, wherein the second connecting member of the second valve body has a trough with a block on an inner wall of the trough, a slide groove is disposed on an outer wall of the first connecting member and has a first locking position and a second locking position, and after inserted into the first locking position and moved a distance, the block is locked at the second locking position.

4. The switch valve of the claim 1, wherein the first connecting member of the first valve body has a first end surface for touching the second slide member, while the first slide member has a second end surface for touching the second connecting member, with a height difference between the first end surface and the second end surface.

5. The switch valve of the claim 1, wherein the second connecting member of the second valve body has a trough, the bottom of the trough has a protrusion, and the height of the protrusion is lower than the height of the second slide member above the bottom of the trough,

6. The switch valve of the claim 1, wherein the first connecting member of the first valve body has a positioning post, and the second connecting member of the second valve body has a positioning notch for the insert of the positioning post.

7. The switch valve of the claim 6, wherein an outer wall of the first connecting member has a slide groove, the slide groove has a first locking position and a second locking position, and the distance between the first locking position and the second locking position is equal to the length of the positioning post.

8. The switch valve of the claim 1, further comprising a foam filling around the second slide member.

9. The switch valve of the claim 1, further comprising a seal ring between the first connecting member and the second connecting member.

10. The switch valve of the claim 1, wherein before the first connecting member touches the second slide member but does not pushes the second slide member, the second connecting member is not in contact with the first slide member.

11. A fuel cell, comprising:
a cartridge;
a switch valve, comprising a first valve body and a second valve body, wherein the first valve body is connected to the cartridge and has a first connecting member and a first slide member, while one end of the second valve body is connected to the first valve body, and the second valve body has a second connecting member and a second slide member, and during assembling operation of the first valve body and the second valve body, the first connecting member gets the second slide member moving to open the second valve body, and the second connecting member gets the first slide member moving to open the first valve body, while during disassembling operation of the first valve body and the second valve body, the first valve body is closed before the second valve body is closed;
a pipeline, connected to the other end of the second valve body;
a pump, connected to the pipeline; and
a fuel cell stack, connected to the pump.

12. The fuel cell of the claim 11, wherein the second connecting member of the second valve body has a trough for the insert of the first valve body, and the second slide member is protrudent on the bottom of the trough.

13. The fuel cell of the claim 11, wherein the second connecting member of the second valve body has a trough with a block on an inner wall of the trough, a slide groove is disposed on an outer wall of the first connecting member and has a first locking position and a second locking position, and after inserted into the first locking position and moved a distance, the block is locked at the second locking position.

14. The fuel cell of the claim 11, wherein the first connecting member of the first valve body has a first end surface, for touching the second slide member, while the first slide member has a second end surface for touching the second connecting member, with a height difference between the first end surface and the second end surface.

15. The fuel cell of the claim 11, wherein the second connecting member of the second valve body has a trough, the bottom of the trough has a protrusion, and the height of the protrusion is lower than the height of second slide member above the bottom of the trough,

16. The fuel cell of the claim 11, wherein the first connecting member of the first valve body has a positioning post, and the second connecting member of the second valve body has a positioning notch for the insert of the positioning post.

17. The fuel cell of the claim 16, wherein an outer wall of the first connecting member has a slide groove, the slide groove has a first locking position and a second locking position, the distance between the t first locking position and the second locking position is equal to the length of the positioning post.

18. The fuel cell of the claim 11, further comprising a foam filling around the second slide member.

19. The fuel cell of the claim 11, further comprising a seal ring between the first connecting member and the second connecting member.

20. A fuel cell, comprising:
a cartridge;
a switch valve, comprising a first valve body and a second valve body, wherein the first valve body is connected to the cartridge and has a first connecting member and a first slide member, while one end of the second valve body is connected to the first valve body, and the second valve body has a second connecting member and a second slide member, and during assembling operation of the first valve body and the second valve body, before the first connecting member touches the second slide member but does not pushes the second slide member, the second connecting member is not in contact with the first slide member;
a pipeline, connected to the other end of the second valve body;
a pump, connected to the pipeline; and
a fuel cell stack, connected to the pump.
